(19) United States
(12) Patent Application Publication
(10) Pub. No.: US 2026/0287134 A1
(43) Pub. Date: Sep. 24, 2026

(54) DEVICE FOR EMITTING A LIGHT BEAM INTENDED TO BE INSTALLED IN A LIGHTING DEVICE WITH A VIEW TO GENERATING LIGHT EFFECTS

(71) Applicant: ARTEFFECT, Romainville (FR)

(72) Inventors: Philippe NATCHOO, Roissy-en-Brie (FR); Charles COMPERAT, Chavanges (FR); Simon BLATRIX, Paris (FR)

(21) Appl. No.: 19/475,976

(22) PCT Filed: Apr. 19, 2024
(86) PCT No.: PCT/EP2024/060849

§ 371 Date: Oct. 16, 2025

(30) Foreign Application Priority Data
Apr. 20, 2023 (FR) 2304009

(51) Int. Cl. F21S 10/00; F21V 15/01; F21V 17/06; F21V 23/00; F21V 29/503; F21V 29/54; F21W 131/406; F21Y 115/30

(52) U.S. Cl. CPC F21S 10/005; F21V 15/01; F21V 17/06; F21V 23/009; F21V 29/503; F21V 29/54; F21V 2200/10; F21W 2131/406; F21Y 2115/30

(57) ABSTRACT

A device for emitting a light beam for use in a lighting device, allowing light effects to be created is disclosed. The device includes a laser source and structure for transmitting at least one laser beam emitted by the laser source to an optical device of the lighting device. The transmitting structure includes an optical fiber, one end of which is connected to the laser source and the other end of which is connected to the optical device of the lighting device, the device further including structure for protecting at least one portion of the optical fiber extending between the two ends of the fiber.

The present invention relates to a device for emitting a light beam for installation in a lighting or illumination device for creating lighting effects, such as a laser-scanning lighting projector. The field of the invention is more particularly that of scenic lighting, in particular in the architectural and entertainment fields, for example in discotheques, theaters for concerts, parades, theatrical performances, live shows, dance, for public and private events, television broadcasts, etc.

A lighting device of this type has been described in document FR-A-3 006 454 and comprises: at least one light source arranged to emit a light beam, an optical device arranged to send each light beam from a central area in several possible directions contained in a light cone whose apex is located in the central area, so that each light beam propagates in its light cone, preferably an enclosed space (containing suspended elements arranged to diffuse the light of each light beam, and a reflector system arranged to receive each light beam propagating in its light cone or plane and to reflect each received light beam into a space (preferably into the above optional enclosed space), said reflector system preferably being arranged to move between several positions so that a change of position alters the trajectory of a light beam reflected by the reflector system. Such a lighting device converts a light beam into a light surface.

Each source preferably comprises a laser or a light-emitting diode or any other suitable light source. The optical device itself comprises a reflective surface mounted so as to rotate about an axis in the central area of the lighting device.

This reflective surface is preferably arranged to reflect each light beam so that, after reflection by the reflective surface, each light beam propagates in its light cone or in a plane in a direction which preferably depends on an angular position of the reflective surface about its axis.

The optical device therefore includes a reflective surface, a support for this reflective surface and control means arranged to control rotation of the reflective surface about its axis.

Above a rotation speed @ of the optical device about its axis, persistence of vision will give the viewer the impression of seeing a luminous surface whose shape will vary according to the instants at which each of the sources emits its beam; the shape of the luminous surface, initially contained within the light cone of this beam, is modified by reflection on the reflector system which takes this beam and therefore this “luminous surface” outside the light cone of this beam. In this case, the optical system converts each light beam into a first portion of “luminous surface” along its light cone inside the enclosed space, then this luminous surface is deployed inside the enclosed space in a second portion outside the light cone of this beam after being reflected by the reflector system.

An optical device of this type is described in FR-A-3 101 439 in the form of an optical module that can be integrated into a lighting device to create lighting effects. Such a module is therefore more compact, making it easier to integrate into the lighting system and facilitate maintenance.

In such a lighting device, the laser source used as the light beam emitting source is constrained to a positioning proximate to the reflector system in order to limit the complexity of the optical path linked to the use of too many mirrors to guide the laser beam between the source and said optical device. Furthermore, the optical path of the laser beam must be safe, to meet maintenance safety requirements.

When use of a laser source of the RGB (red, green, blue) type is desired, which is generally made up of several different colored diodes, all with different characteristics, it is necessary to superimpose them using complex sets of mirrors and lenses, necessitating complicated, slow and costly alignment procedures.

Furthermore, the result of this alignment is rarely perfect in terms of repeatability, and unstable over time. Additionally, precise laser beam characteristics at the source output are required to comply with safety standards.

As a result, it is difficult to offer a lighting device that is as compact as possible, while still offering the correct operating characteristics.

Optical fibers are also known as means of transmitting a light beam from a laser source. US-A-202000348 describes a device for emitting a white light beam from laser sources, comprising an optical fiber for transporting the emitted light beam from the laser sources to an optical device, the optical fiber being housed in a flexible tube. Such a device is relatively bulky and unwieldy.

Document CN206496309 proposes a lighting device emitting a multicolor tracking light beam. The device thus consists of a housing containing the laser sources, and an optical device, with light fluxes passing from the laser source to the optical device via optical fibers, wound around a column contained between within the housing. Such a device is therefore a tracking projector, each component of which is contained in a single housing.

In order to overcome these disadvantages, according to a first aspect of the invention, the invention relates to a device for emitting a light beam intended to be installed in a lighting device to generate lighting effects, and which can in particular be positioned at a distance from the optical device of said lighting device.

According to a second aspect of the invention, the purpose of the invention is to provide a lighting device wherein the laser source can be offset with respect to the optical device integrated in said lighting device, thus allowing greater modularity and/or compactness for said lighting device.

To this end, the invention relates to a device for emitting a light beam for use in a lighting device, allowing light effects to be created, said device comprising:
a laser source and means for transmitting at least one laser beam emitted by the laser source to an optical device of the lighting device,
characterized in that the transmitting means comprise an optical fiber, one end of which is connected to the laser source and the other end of which is intended to be connected to the optical device of said lighting device, the device further comprising means for protecting at least one portion of the optical fiber extending between its two ends.

Advantageously, the light beam or flux is transported from the laser source to the lighting device by means of an optical fiber, generally with a minimum length, preferably 1 m, which allows the mixing of the different modes/wavelengths of the laser source, the transmission of the light beam being guaranteed between the two ends of the optical fiber by said protection means. These protection means prevent deformation or damage to the optical fiber, particularly during installation in the lighting device, which could degrade the transmitted light beam.

An optical fiber is a wire whose core, made of glass or plastic, has the property of conducting light, thus allowing the laser beam emitted by the laser diode(s) to be easily and safely conducted to the optical device of the lighting system.

The optical fiber is therefore a waveguide that exploits the refractive properties of light, the core of which, that is surrounded by a protective cladding, has a slightly higher refractive index (a difference of a few thousandths) than that of the cladding, and can therefore confine light that is completely reflected multiple times at the interface between the two materials (due to the phenomenon of total internal reflection).

When a light beam enters an optical fiber at one of its ends at a suitable angle, it undergoes multiple total internal reflections. This beam then travels to the other end of the optical fiber without loss, following a zigzag path. Light propagation in the fiber can take place with very little loss, even when the fiber is bent.

An optical fiber is characterized by both its core diameter and its numerical aperture. The numerical aperture of the fiber is concretely the sine of the maximum angle at which light can enter the fiber so that it can be guided without loss, measured with respect to the fiber axis. The optical fiber used in a device according to the invention is a commercially available optical fiber.

The laser source consists of at least one laser diode, and preferably several laser diodes of different colors, such as RGB diodes. The light fluxes of the laser diodes are focused at the source output in the optical fiber. In the case of RGB laser diodes, a minimum length of optical fiber is required to mix the colors or light flux emitted by each laser diode, to obtain the most homogeneous and whitest beam possible at the fiber optic output, for example.

It is thus the propagation of the beams emitted in the optical fiber that mixes and superimposes the colors. Advantageously, a device based on the invention eliminates the need for complex alignment procedures in the source, linked to the diodes. Furthermore, the beam leaving the fiber is circular and perfectly repeatable.

The device according to the invention comprising an optical fiber of a certain length, in particular to allow color mixing, said length can be used to define a freer positioning of the laser source, with respect to that of the optical device of said lighting device, allowing an arrangement wherein the laser source can be either within the lighting device, or even outside it.

Thus, the device according to the invention can emit a light flux that can be guided to the optical device of a lighting or illumination device without the need to position this device, and in particular the laser source, proximate to said optical device, as opposed to an optical path made up of lenses and mirrors.

Thus, advantageously, since the device according to the invention comprises an optical fiber to convey the light beam, said lighting device no longer needs to comprise a complex optical path between the laser source and the optical device.

As a result, not only is a homogeneous light beam guaranteed due to the minimum length of the optical fiber, which allows good mixing of the modes and wavelengths of the beams originating from the laser source, but the length of said optical fiber also allows the light source to be positioned more freely, in particular at a distance from the optical device of the lighting device, and the length of the optical fiber can further be selected based on this more or less distant position.

The device according to the invention also includes means for cooling the laser source, means for electronically controlling said laser source and optical means to which the end of the optical fiber opposite its end connected to the laser source is connected, said optical means allowing the transformation of the light beam at the output of the optical fiber and its emission to the optical device of a lighting device.

Advantageously, these optical means allow the light beam from said optical fiber to be transformed, corrected and directed toward the optical device of the lighting device. These optical means comprise means for correcting, for example, the divergence of said beam from the optical fiber, or the width of the beam. These optical means consist, for example, of a collimator with an appropriate focal length. These optical means can be connected to the optical device of the lighting device.

The optical means, such as the collimator, thus make it possible to reduce the aperture angle of the divergent beam exiting the optical fiber, which is generally too large, in order to form a beam of divergence and diameter more suitable for the optical device of the lighting device, such as a laser-scanning lighting projector.

The device according to the invention may further comprise one or more of the following features, taken alone or in combination:
The optical fiber protection means consist of a housing in which the optical fiber is housed, said housing including means for holding the optical fiber in wound form with a minimum radius of curvature.
The holding means are provided on the bottom of the housing, the peripheral wall of the housing and/or the end of said peripheral wall.
The holding means consist of the wall(s) of the housing against which the wound optical fiber generally rests when it is deposited wound in said housing. In fact, the wound fiber tends to want to “unwind” and is therefore forced to remain in wound form by said walls.
The holding means consist of tongues projecting from the bottom, the peripheral wall and/or the end of said peripheral wall of the housing, to form a receiving space between a tongue and the bottom, the peripheral wall and/or the end of said peripheral wall, in which receiving space the optical fiber is housed and held.
The holding means, such as the tongues, are preferably distributed over the face of the peripheral wall of the housing so as to form a helical winding of the optical fiber along the wall.
The peripheral wall of the housing has a flange at its end, on which the optical fiber is positioned and wound, held in place by holding means provided on said flange.
The optical means such as a collimator, to which one end of the optical fiber is attached, are housed in the housing. In particular, the collimator consists of a converging lens whose focal length allows the divergent rays of the output beam to be brought parallel to the optical axis and to one another, allowing them to be emitted toward the optical device of the lighting device.
The bottom of the housing includes a tubular element projecting toward the outside of the housing, in which optical means such as a collimator are housed, to which one end of the optical fiber is attached.
The housing includes a bottom and a peripheral wall defining a peripheral contour of curved shape, such as circular, ovoid, or having linear portions connected by curved portions, the peripheral contour defining the optical fiber winding.
The housing comprises a base and peripheral walls defining a parallelepiped shape of the housing, the holding means such as the walls themselves, tongues defining the winding.
The housing can remain open (without a closing cover) or have a closing cover.

In this way, the housing, known as the winder, in which the optical fiber is housed in a tightly wound manner, ensures the preservation of the optical fiber and therefore its correct operation, by ensuring a minimum radius of curvature, which limits optical losses in the optical fiber.

This minimum radius of curvature corresponds to a fiber optic operation that ensures good quality transmission of the light beam inside the optical fiber. If this minimum radius of curvature is not respected, the reflection of the light beam may be degraded, and therefore its propagation between the two ends of the optical fiber may also be degraded. Additionally, winding the optical fiber without respecting this minimum radius of curvature can cause damage to the optical fiber itself. This minimum radius of curvature can therefore be determined based on the characteristics of the optical fiber used and the characteristics of the light beam desired to emerge from said fiber.

The light beam emitting device according to the invention allows controlled and repeatable positioning and winding of the optical fiber to guarantee the repeatability of the optical characteristics at the source output, which is necessary for compliance with standards.

As already mentioned, the light beam emitting device according to the invention further includes means for cooling the laser source, electronic control means for said laser source and optical means for transforming the light beam at the output of the optical fiber. All these elements can be assembled in the form of a module, which can be integrated into a lighting device either aligned with the optical device or offset from it.

In this way, the device takes the form of an emission module wherein cooling means provide support for the other elements of the device, such as the laser source, the electronic control means and the housing, which preferably contains only part of the wound optical fiber.

According to a variant, the device takes the form of an emission module wherein the housing containing part of the wound optical fiber, and preferably only the optical fiber, constitutes support means for the other elements of the device, such as the laser source, electronic control means and cooling means.

The housing can further be independent of the cooling means, the control means and the laser source. The length of the optical fiber between the laser source and the housing can be varied to allow remote positioning. The length of the optical fiber end connectable to the optical means can also be variable to allow remote positioning of the lighting device.

In either of these modules, the optical means mounted at the end of the optical fiber which is outside the housing can also be carried by the housing, and each module is then integrable into the lighting device so that said optical means and the end of the optical fiber are connected to the optical device of said lighting device with the entire emission module.

Alternatively, the optical means and the end of the optical fiber are independent of the other elements of the device constituting an emission module, so that said optical means are connectable to the optical device of the lighting device independently of the emission module and can thus be integrated into the lighting device in a manner offset from said optical means.

The housing in which the optical fiber is held allows the optical fiber to be perfectly positioned, guaranteeing a minimum radius of curvature that is repeatable from one product to the next, while limiting the space required for fibers that can be more than 1 m long; the device thus created can be integrated in a small form and integrated into the smallest possible lighting products.

The invention also has a lighting device for generating lighting effects from a light beam, characterized in that it comprises a device for emitting the light beam according to the invention.

The invention relates in particular to a lighting device of the type comprising a device for emitting a light beam, an optical device such as a rotatably drivable mounted support wherein a reflective optical component is mounted, the support comprising at least one sleeve coaxial with the rotary drive axis and having an end defining an inlet aperture for a light beam and having, in its wall, an aperture defining an outlet aperture for the light beam reflected on the reflecting optical component, and a reflector system, characterized in that it includes, as light beam emitting device, a light beam emitting device according to the invention.

The optical means such as the collimator, mounted at the end of the optical fiber, are installed in the lighting device, aligned with the optical axis of the optical device so as to emit the light beam directly into said optical device. It is also possible for these optical means to be positioned in the lighting device so as to emit the light beam indirectly toward the optical device.

The invention will be well understood and other aspects and advantages will become clear from the following description, given by way of example with reference to the appended sheet of drawings, on which the figures represent:

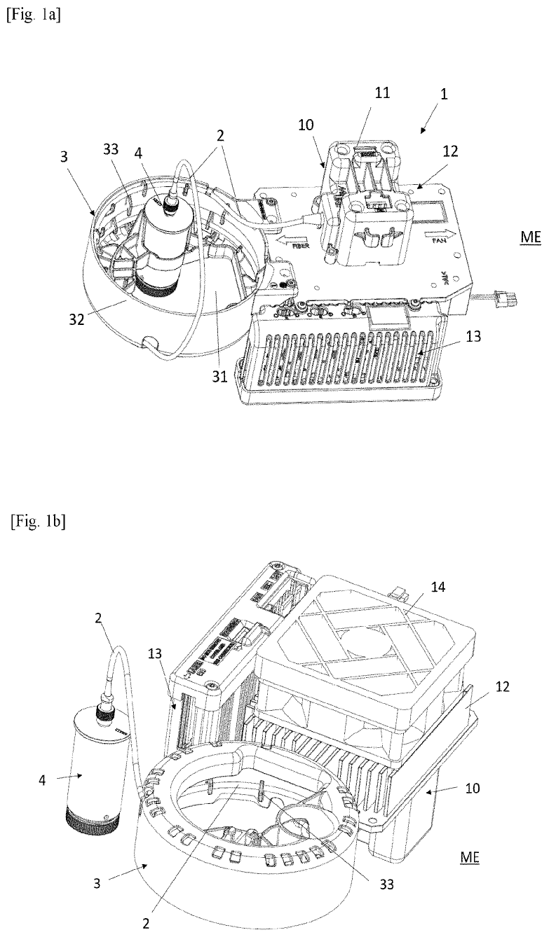

FIG. 1a a top perspective view of a first example embodiment of a light beam emitting device according to the invention;

FIG. 1b a perspective bottom view of the device according to FIG. 1a;

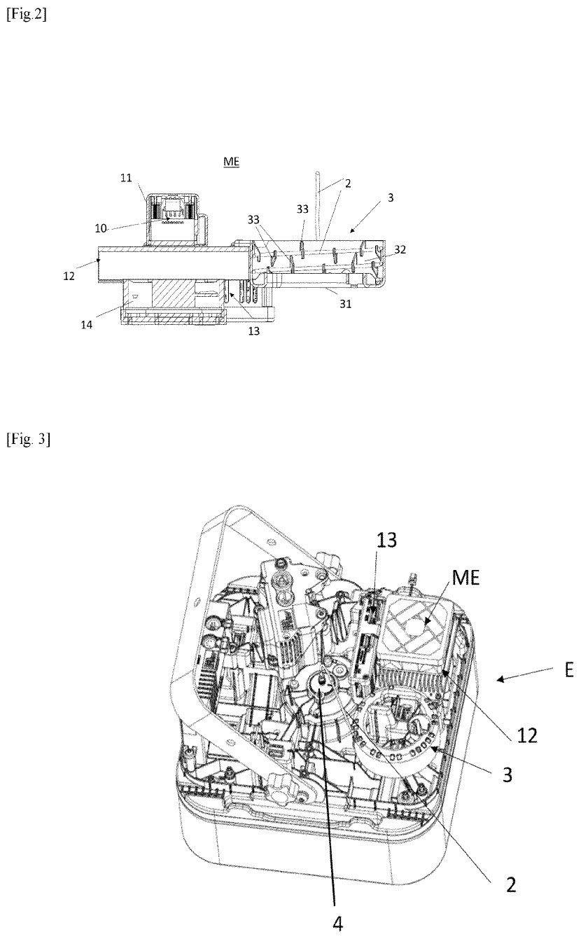

FIG. 2 a sectional view of the device of Figure la;

FIG. 3 a cross sectional view of a lighting device including a device according to FIG. 1a;

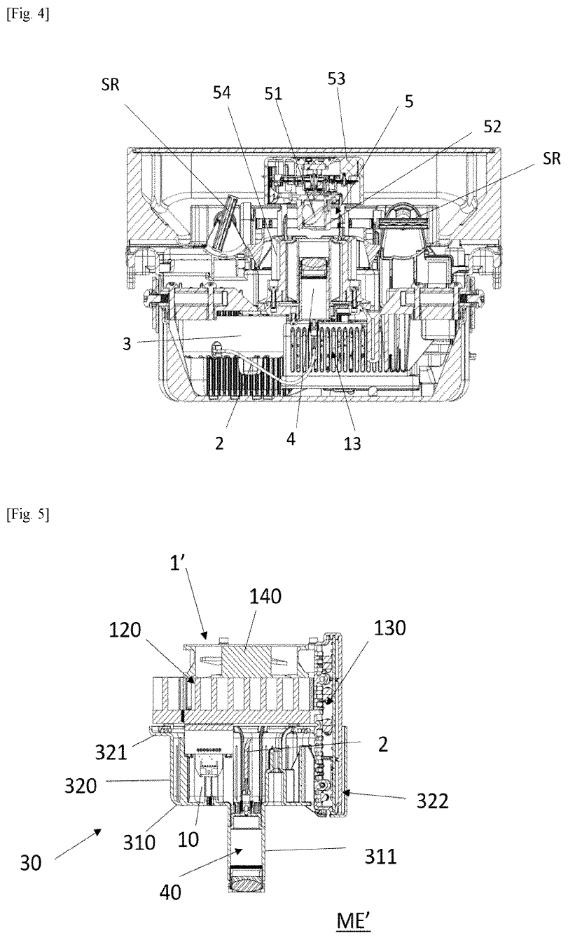

FIG. 4 a perspective top view of the lower part of the lighting device of FIG. 3;

FIG. 5 a longitudinal cross sectional view of a second example embodiment of a light beam emitting device according to the invention;

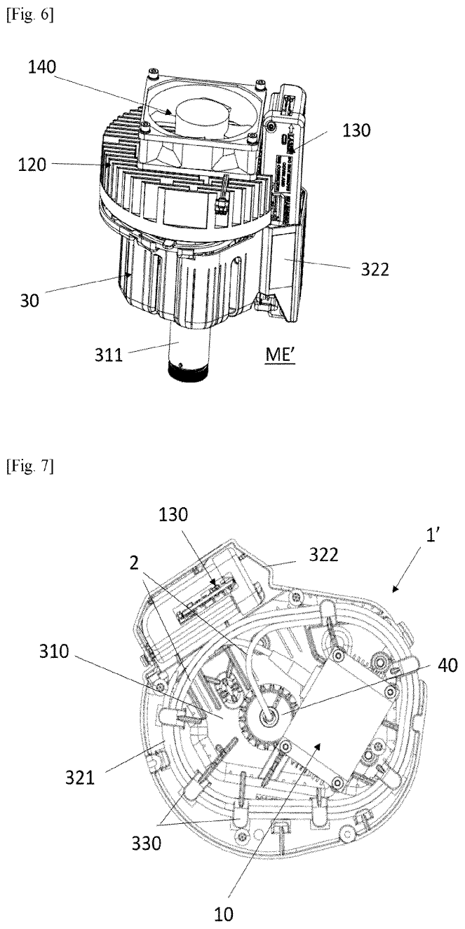

FIG. 6 a perspective top view of the device according to FIG. 5;

FIG. 7 a perspective top view of the lower part of the device according to FIG. 5;

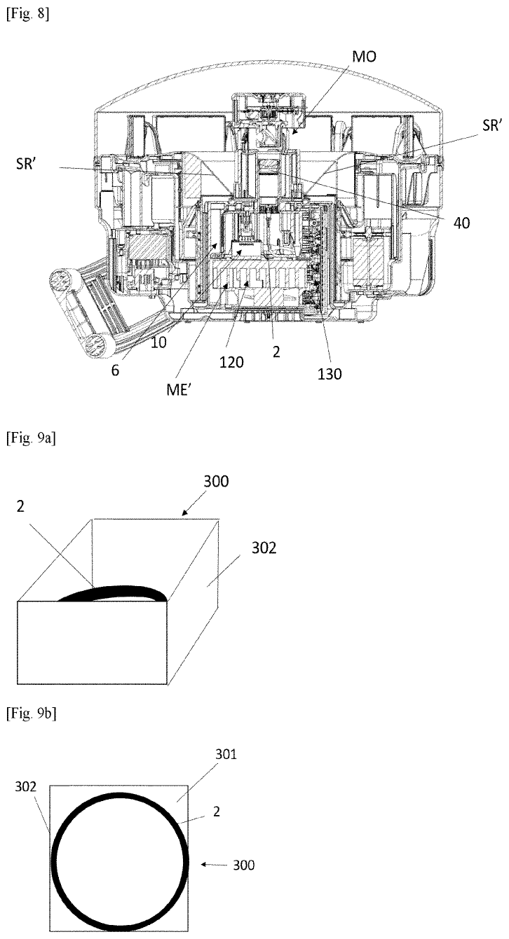

FIG. 8 a longitudinal cross sectional view of a lighting device E of the device of FIG. 5;

FIG. 9a a perspective view of an example housing for a device according to the invention; and

FIG. 9b a bottom view of the housing of FIG. 9a.

The light beam emitting device 1 according to the invention comprises a laser source 10 and an optical fiber 2, one end of which is connected to the laser source 10 and the other end of which is intended to be connected to a lighting device E.

The laser source 10 consists of one or more laser diodes. The optical fiber 2 is therefore connected at one end to said laser diodes and at its opposite end to the optical device 5 of a lighting device E via optical means such as a collimator 4.

Associated with this laser source 10 are means for cooling said laser source 10 and electronic control means 13 for the laser source 1 and the cooling means. Preferably, these control means 13 are intended to be in communication with control means of the lighting device E.

The cooling means consist, for example, of a Peltier effect cooling system, associated with a temperature sensor such as a thermistor housed in the laser source 10, a heat sink 12 and a fan 14.

In the example shown in FIGS. 1a, 1b and 2, the Peltier effect cooling system 12 is integrated into the laser source 10, which is mounted on the heat sink 12 and protected by a protective cover 11. It is also possible that the Peltier effect cooling system is not integrated into the laser source 10 but is, for example, interposed between the laser source 10 and the heat sink 12.

The laser source 10 comprises one or more laser diodes of one or more colors. Each laser diode is a semiconductor-based optoelectronic component that emits coherent monochromatic light, the light from each diode being focused at the output of the laser source 10 in the optical fiber 2.

This optical fiber 2 therefore allows the laser beam(s) emitted by the laser diodes to be transmitted, and has a minimum length of 100 cm, preferably 120 cm, so that when diodes of different colors are used, the propagation in the optical fiber 2 of the different beams allows the colors at the fiber output to be mixed and superimposed.

This length, necessary for homogeneous mixing, allows transmission from the laser source 10 to the optical device 5 of the lighting device E, and also allows the laser source 10 to be positioned at a distance from the optical device 5.

In order to guarantee optimum transmission of the laser beam in the fiber 2, the device 1 includes means for protecting the optical fiber 2, consisting of a housing 3 in which the optical fiber 2 can be held securely, thereby protecting the optical fiber 2 and guaranteeing the quality of the transmitted light beam.

Such a housing 3 is provided with a bottom 31 and a peripheral wall 32. On its inner face, this peripheral wall 32 has means for holding the optical fiber, such as tongues 33 projecting from said face and forming a receiving space in which the optical fiber 2 is housed and held wound by said tongues 33. These tongues are L-shaped and define a U-shaped receiving space with the wall 32 of the housing, in which the optical fiber 2 is engaged and held by contact. These holding means can also be designed in the form of a retaining hook or any other suitable shape, allowing the optical fiber 2 to be held without “injuring” it, by crushing for example. The housing

Because of the limitation on the radius of curvature of the optical fiber 2 to avoid optical losses in the optical fiber 2, the housing 31 has dimensions such that the optical fiber 2 is wound at least to its minimum radius of curvature, that is, the radius wherein neither the quality of the light beam nor the optical fiber 2 itself is damaged. In the example shown, the housing 3 has a circular cross-section, the radius of which corresponds, for example, to the minimum radius of curvature of the optical fiber 2.

Preferably, the tongues 33 are distributed over the face of the peripheral wall 32 so as to form a winding spiral for the optical fiber 2.

Optical means, such as a collimator 4, are connected to the free end of the optical fiber 2 and thus allow the desired beam characteristics to be obtained for entry into the optical device 5 of the lighting device E. They are housed in the housing 3 awaiting assembly, as can be seen in Figure la.

The optical means, such as the collimator 4, make it possible in particular to reduce the aperture angle to collimate the beam exiting the optical fiber 2, which is generally too large, in order to form a beam of divergence and diameter more suitable for orienting it toward the optical device 5 of the lighting device E, such as a laser-scanning lighting projector. To reduce chromatism in multi-color/wavelength lasers, the collimator consists of an achromatic doublet, or even an achromatic triplet, instead of a single lens.

As shown in FIGS. 1a, 1b and 2, the device 1 takes the form of a module, with the heat sink 12 of the cooling means acting as support means for other components such as the laser source 10, the electronic control means 13 and the housing 3 containing the wound optical fiber 2. In Figure la, the collimator 4 is positioned in the winding housing 3 awaiting assembly, for example, but it can be positioned remotely (see FIG. 1b) with respect to the emission module ME formed and positioned as required when integrated in a lighting device E.

Thus, the device 1 in the form of an emission module ME is attached to a lighting device E, in particular to a lower part E1 of said lighting device E, and the collimator 4 connected to the free end of the optical fiber 2 is then positioned in the lighting device E so as to be centered directly at said optical device 5 to send the emitted light beam toward said optical device while the emission module ME is positioned offset from said optical device 5, as can be seen in FIGS. 3 and 4.

This optical device 5 comprises a support mounted on a rotary drive motor and a reflective optical component 51, the support comprising at least one sleeve 52 coaxial with the rotary drive axis. The sleeve 52 has one end defining an inlet aperture and an opening in its wall defining an outlet aperture. The reflective optical component 51 is housed in this sleeve 52, so that a light beam entering through the inlet aperture is reflected by the reflective optical component 51 and exits through the outlet aperture.

The optical device 5 further comprises a protective cover 53 wherein the optical device and the control means of said optical device 5 are attached, allowing them to be easily mounted in a lighting device E as a unitary assembly, ready for use. The optical device 5 also comprises a mounting base 54, connected to the protective cover 53.

The mounting base 54 comprises a central well 55 allowing the light beam to pass to the reflective optical component 51 positioned above this mounting base 54, connecting means being provided extending between the protective cover 50 and the mounting base 54 and maintaining a gap between said protective cover 50 and the mounting base 54, into which gap the optical component 51 projects.

The result is an optical device 5 integrated into an optical module MO (such as that described in FR-A-3101439, for example) that can be easily installed within the lighting device E, simply by fitting said optical module MO, which integrates all the elements required to achieve the desired visual effects. The collimator 4 is thus positioned in the lighting device E at a distance from the emission module ME formed by the other elements of the device 1, so that it can be engaged in the central well 55 of the optical module MO. In this way, the light beam emitted by the collimator 4 enters the optical device 5 through the inlet aperture of the sleeve 52, which is then deflected by the reflective optical component 51.

As shown in FIG. 4, the lighting device E also includes an upper part E2, which closes off the lower part. This upper part of the closing cover also includes a reflector system SR made up of mirrors surrounding the optical device 5 to reflect the laser surface thus created through 360°.

In the example shown in FIGS. 5 and 6, the light beam emitting device 1′ comprises a laser source 10, cooling means including a heat sink 120 and a fan 140, electronic control means 130, a housing 30 in which the optical fiber 2 is held wound, and optical means such as a collimator 40.

The means for protecting the optical fiber 2 consist of a housing 30 including a base 310 and a peripheral wall 320, the end of which includes a flange 321 with a rim over most of its periphery, and on which the optical fiber 2 wound in flat turns is positioned, the latter being held under retaining tabs 330 provided on said flange 321.

The peripheral contour of the housing 30 may have a circular shape or preferably curved parts and more linear parts defining the winding of the optical fiber 2 on said flange 321, while the portion of the peripheral wall 320 not having a flange 321 and therefore not receiving the optical fiber 2 delimits a lateral compartment 322.

The heat sink 120 and the fan 140 of the cooling means forming a cover for the device 1′ are mounted on the open face of the housing 30, while the electronic control means 130 are housed in the lateral compartment 322 and also extend along the cooling means 120, 140.

The bottom 310 of the housing 30 further includes a central tubular projection 311 extending outwards from the housing 30, in which the collimator 40 is housed.

The housing 30 also houses the laser source 10 attached to the bottom 310. The optical fiber 2 thus extends from the upper part of the laser source 10 and is wound flat onto the flange 321, and held under the tongues 330. Means for connecting said laser source 10 to the electronic control means 130 also extend from the laser source 10.

These components of the device 1′ are arranged in a compact emission module ME′, which also incorporates the collimator 40.

The device 1′ thus formed in the form of an emission module ME′ has a compact shape which can be integrated into a lighting device E′ which comprises an optical module MO as described above and a receiving compartment 6 into which the emission module ME′ can be inserted.

As can be seen in FIG. 8, the tubular projection 311 of the device 10 is engaged in the central well 55 of the optical module MO. The collimator 40 is thus integrated into the optical module MO, aligned with the optical device 5. In the device shown in FIG. 8, the lighting device comprises a reflector system SR′ consisting of a surface extending around the optical device 5 and mounted so as to be movable with respect to said optical device, as described in FR-A-3108965.

FIGS. 9a and 9b show an example of a housing 300 with a parallelepiped shape defined by the bottom 301 and the peripheral wall 302. The wound optical fiber 2 is housed in this housing 300 and the peripheral wall 302 constitutes the means for holding the optical fiber 2. Indeed, the latter is wound in the housing and held against the peripheral wall 302, which keeps it wound.

Because of the limitation on the radius of curvature of the optical fiber 2 to avoid optical losses in the optical fiber 2, the housing 300 has dimensions such that the optical fiber 2 is wound at least to its minimum radius of curvature, that is, the radius wherein neither the quality of the light beam nor the optical fiber 2 itself is damaged. In this embodiment, the housing 300 may comprise a cover.

Of course, other holding means such as tongues can also be provided.

1. A device for emitting a light beam for use in a lighting device allowing light effects to be created, said device comprising: a laser source; and means for transmitting at least one laser beam emitted by the laser source to an optical device of the lighting device;
the transmitting means comprise an optical fiber, one end of which is connected to the laser source and the other end of which is connectable to the optical device of said lighting device, the device further comprising means for protecting at least one portion of the optical fiber extending between its two ends.

2. The device according to claim 1, characterized in that it further includes means for cooling the laser source, means for electronically controlling said laser source and optical means to which the end of the optical fiber opposite said end connected to the laser source is connected, said optical means allowing the transformation of the light beam at the output of the optical fiber and its emission to the optical device of a lighting device.

3. device according to claim 1, characterized in that the optical fiber protection means include a housing in which the optical fiber is housed, said housing including means for holding the optical fiber in wound form with a minimum radius of curvature.

4. The device according to claim 3, characterized in that the holding means include the wall(s) of the housing against which the wound optical fiber rests when said fiber is positioned wound in said housing.

5. The device according to claim 3, characterized in that the holding means are provided on the bottom of the housing, the peripheral wall of the housing and/or the end of said peripheral wall to form a receiving space in which the optical fiber is housed and held wound in the housing.

6. The device according to claim 3, characterized in that the holding means include tongues projecting from the bottom, the peripheral wall and/or the end of said peripheral wall of the housing, to form a receiving space between a tongue and the bottom, the peripheral wall and/or the end of said peripheral wall in which receiving space the optical fiber is housed and held.

7. The device according to-one claim 5, characterized in that the peripheral wall of the housing has a flange at its end, on which the optical fiber is positioned and wound, held in place by holding means provided on said flange.

8. The device according to claim 3, characterized in that the housing includes a bottom and a peripheral wall defining a peripheral contour of curved shape, including one of circular, ovoid, and having linear portions connected by curved portions.

9. The device according to claim 3, characterized in that the housing includes a bottom and a peripheral wall defining a parallelepiped shape of the housing.

10. The device according to-one claim 3, characterized in that the optical means to which one end of the optical fiber is attached are housed in the housing.

11. The device according to claim 8, characterized in that the bottom of the housing includes a tubular element projecting toward the outside of the housing, in which the optical means are housed, to which one end of the optical fiber is attached.

12. The device according claim 3, characterized in that said device takes the form of an emission module wherein the cooling means provide support for the other elements of the device, including the laser source the electronic control means and the housing, containing part of the wound optical fiber.

13. The device according to-one claim 3, characterized in that said device is in the form of an emission module wherein the housing provides support means for the other elements of the device, including the laser source the electronic control means and the cooling means.

14. A lighting device for generating lighting effects from a light beam, characterized in that said device comprises a device for emitting the light beam according to claim 1.
